(19) United States
(12) Patent Application Publication
(10) Pub. No.: US 2025/0165225 A1
(43) Pub. Date: May 22, 2025

(54) PREDICTIVELY GENERATING A PAYLOAD FOR AN INCREMENTAL BUILD BASED ON CODE CHANGES IN A CODE BASE

(71) Applicant: Microsoft Technology Licensing, LLC, Redmond, WA (US)

(72) Inventors: David Martin PANKOWSKI, Dublin (IE); Abraham Olise EBUBE, Kildare (IE); Benjamin Andrew MIZERA, Redmond, WA (US); Mert DUATEPE, Dublin (IE); Nikita RESHETNIAK, Dublin (IE); Pratibha N/A, London (GB)

(21) Appl. No.: 18/516,245

(22) Filed: Nov. 21, 2023

(51) Int. Cl. G06F 8/30

(52) U.S. Cl. CPC G06F 8/30

(57) ABSTRACT

Changes to code in a code base are collected and a payload generation system identifies underlying computing items where the changes were made, as well as other items that are used by the underlying items or that are generated by the underlying items. The payload generation system generates a build payload including the identified items so that a build system can generate a build artifact that reflects the aggregated changes.

### BACKGROUND

Computing systems are currently in wide use. Some computing systems host or distribute applications or other systems that are accessed by end users. The hosted or distributed applications or other systems may provide a wide variety of different functionality.

Such applications or systems are often generated using a continuous integration system in which multiple developers can collaborate in generating human readable code that is stored in a shared code base or code repository. Version control is used to resolve editing conflicts among the various developers, and build automation is used to create a machine runnable snapshot of a version of the code, sometimes referred to as a build artifact. The build artifact can then be distributed to end users through any of a variety of networks. For instance, when the build artifact is for a web-based application, the build artifact created during the build process may be copied to a website where it can be accessed by users. When the build artifact is for a mobile application, then the build artifact created during the build process may be copied to a location where the build artifact can be downloaded by a user to a mobile device. When the build artifact is for an operating system, then the build artifact can be deployed in these or other ways.

As the developers continue to develop the code in the code base, updated build artifacts are created to deliver the changes to the end users.

The discussion above is merely provided for general background information and is not intended to be used as an aid in determining the scope of the claimed subject matter.

### SUMMARY

Changes to code in a code base are collected and a payload generation system identifies underlying computing items (such as files, binaries, etc.) where the changes were made, as well as other items that are relied on by the underlying items or that are generated by the underlying items. The payload generation system generates a build payload including the identified items so that a build system can generate a build artifact that reflects the aggregated changes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing one example of a build payload generation system in more detail.

FIG. 3 is a flow diagram illustrating one example of the operation of the computing system architecture.

FIG. 4A is a flow diagram illustrating one example of the operation of the build payload generation system.

FIGS. 4B, 4C, 4D, and 4E show examples of a build payload being generated.

FIG. 5 is a block diagram showing the computing system architecture illustrated in FIG. 1 deployed in a remote server architecture.

FIG. 6 is a block diagram of one example of a computing environment that can be used in the architectures and systems shown in previous figures.

### DETAILED DESCRIPTION

As discussed above, some computing systems use continuous integration systems that allow a plurality of different developers to collaborate on a code base that is stored in a code repository. Some portions of the code in the code base may depend on other code, and these portions of other code may thus be referred to as dependent code (or dependencies).

In such systems, the developers periodically commit changes to the code base. Also, periodically, a new build artifact is generated from the code base (e.g., the code base is compiled) so that a new version of the code (including all the changes or revisions) can be deployed to end users.

In order to identify the items in the code base (e.g., binaries, dependencies, libraries) that need to be deployed to the end users so the end users have the latest version of the code base (a version which captures all of the revisions committed by the developers), some current systems generate a full build to obtain an updated build artifact that reflects all the changes. The updated build artifact is compared to the previous build artifact that was generated from the code base prior to the changes being committed by the developers. The two build artifacts are compared to identify items in the build artifact that changed based on the revisions, and those items can then be deployed to end users so the end users have a version of the code that reflects all of the changes.

However, generating a full build of the code in the code base (simply to identify what has changed) is time consuming and inefficient in that it uses a great deal of computing system resources. In fact, it is not uncommon for some builds to take nearly twenty-four hours to generate. Then, the comparison must be performed (comparing the new full build artifact to the prior full build artifact) in order to identify the items of the computing system that have been changed so that those items can be deployed to end users. This is a highly inefficient and slow process that consumes a large amount of computing system resources.

The present description thus proceeds with respect to a system that predictively identifies the items that are affected by changes committed to a code base since the last build artifact was generated. For instance, the present system identifies the underlying binaries where the changes were made, as well as items that are needed to compile those binaries and items generated by those binaries. Further, where an underlying file depends on a dependency, the dependency is also parsed to identify any additional items that need to be built. All of the identified items are added to a build payload and only the items in the build payload are compiled during the build process. These compiled items can be deployed for use by end users. Thus, the present description allows a new build artifact to be generated in a highly efficient manner using far fewer computing system resources than current systems, even after a single change is committed to the code base by a developer. Only items affected by that single commit are added to the build payload and compiled. By predicting the items that need to be compiled prior to the build process, this eliminates the need to perform two complete builds, to generate two complete build artifacts, and then compare the build artifacts, in order to generate an update package that can be deployed for use by end users.

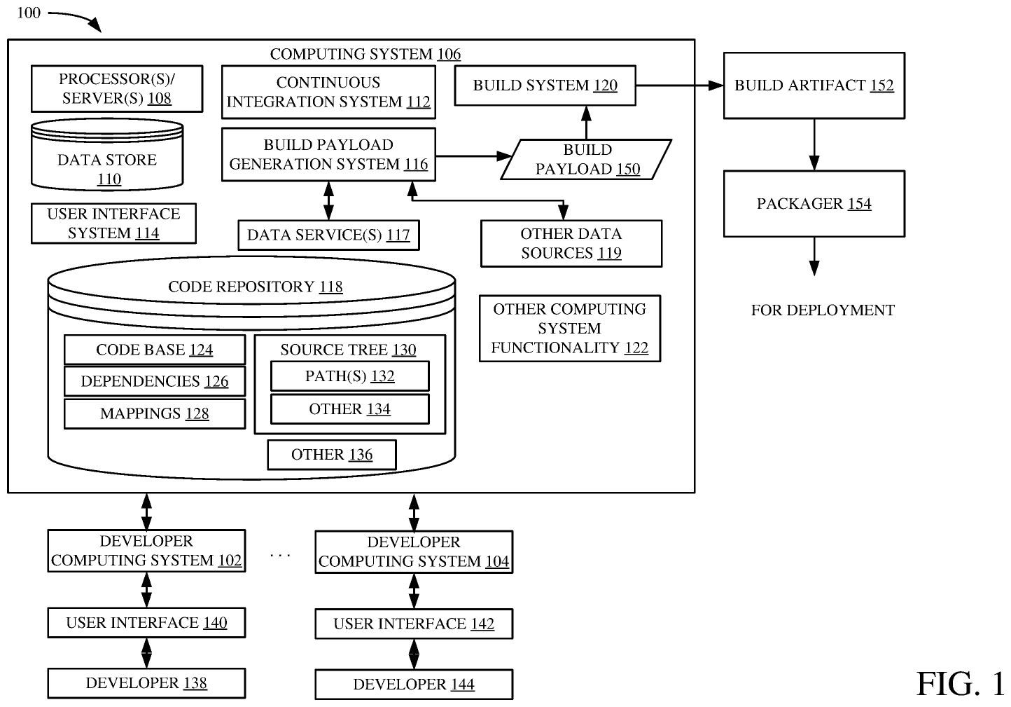

FIG. 1 is a block diagram of one example of a computing system architecture 100. In architecture 100, a plurality of developer computing systems 102-104 have access to computing system 106 which includes one or more processors or servers 108, data store 110, continuous integration system 112, user interface system 114, build payload generation system 116 (which can have access to one or more data services 117 or other information sources 119), code repository 118 (which can alternatively or additionally be stored in other location(s)), build system 120, and any of a wide variety of other computing system functionality 122. The code repository 118 can include a code base 124 of code that is being developed, along with references to dependencies 126, mappings 128, a source tree 130 which can include paths 132, and other items 134, along with any of a wide variety of other items 136.

FIG. 1 also shows that developer computing system 102 generates user interface 140 for interaction by developer 138. Developer 138 has access to developer computing system 102 through user interface 140. Developer 138 can interact with user interface 140 in order to control and manipulate developer computing system 102 and parts of computing system 106. Also, developer computing system 104 generates user interface 142 for interaction by developer 144. Developer 144 can interact with user interface 142 in order to control and manipulate developer computing system 104 and some parts of computing system 106.

During development of the code in code base 124, developers 138 and 144 may make changes or revisions to the code in code base 124 and then perform a commit operation. A commit operation sends the latest change or revision to the code base 124 in the code repository 118. Data services 117 and/or other data sources 119 track information about the code revisions in the code base 124, dependencies 126, paths 132 in source tree 130, mappings 128, etc. When a new build artifact is to be generated, build payload generation system 116 accesses data services 117 and/or other data sources 119 to identify items in code repository 118 that need to be compiled based upon the changes in the commit operations since the last time code base 124 was compiled.

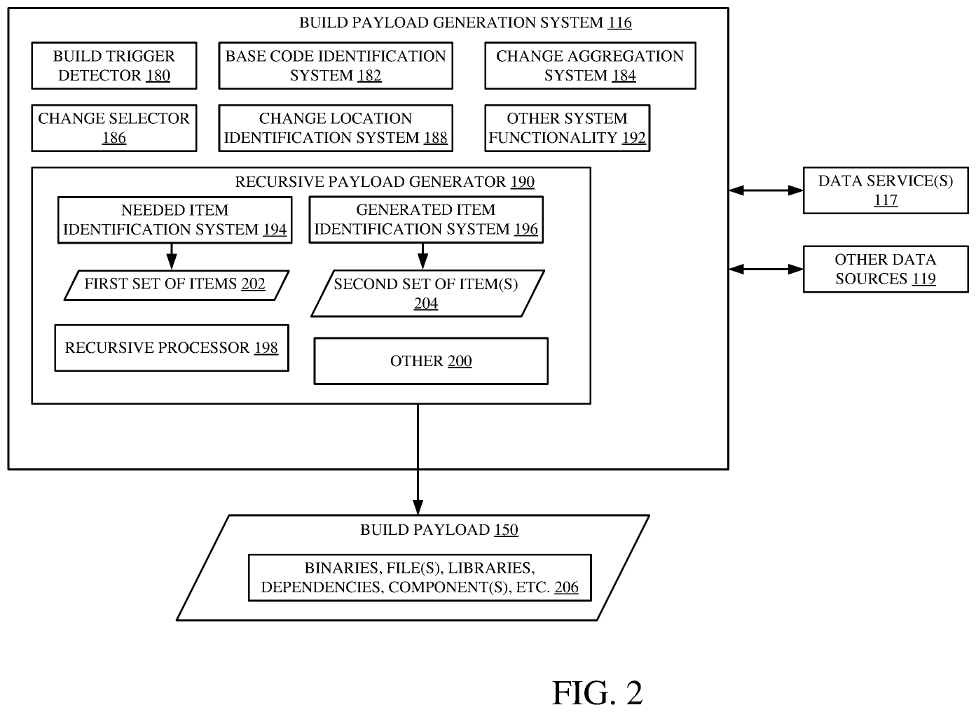

In one example, build payload generation system 116 accesses data services 117 and/or other data sources 119 to identify all commit operations that have been performed with respect to the code in code repository 118 since the last build artifact was generated for that code. For each of those commit operations, build payload generation system 116 accesses data services 117 and/or other data sources 119 to identify items that need to be included in build payload 150 which is provided to build system 120. For instance, build payload generation system 116 can identify the underlying binaries that have been changed based on the changes or revisions in the commit operations, as well as any dependencies that are affected by those changes. Similarly, build payload generation system 116 can identify any items that are needed when the underlying binaries or dependencies are compiled, as well as any items that are output by the underlying binaries and dependencies when they are compiled. All of those items can be included in build payload 150. Further, build payload generation system 116 can recursively identify any additional items that are to be added to the build payload 150, as additional items are identified. This recursive process is described in greater detail below with respect to FIGS. 2-4E.

Once build payload generation system 116 generates build payload 150, build payload 150 is provided to build system 120 which generates a build artifact 152 for the items in build payload 150. The build artifact 152 reflects a compiled version of the items in build payload 150. The build artifact 152 can be provided to a packager 154 or another item which generates an output that can be deployed to end users, or deployed in other ways, so the most recent version of the code in the code base 124 is available to the end users.

It can thus be seen that build payload generation system 116 only adds items to build payload 150 which are affected by the changes that have been made since the last build artifact was generated. Thus, the new build artifact 152 may only be an incremental build of the code in code base 124 which saves a great deal of time over prior systems that generated a full build artifact, because a full build of the code in code base 124 need not be generated to identify items affected by changes or revisions in the recent commit operations.

FIG. 2 shows one example of a block diagram of build payload generation system 116 in more detail. In the example shown in FIG. 2, build payload generation system 116 includes build trigger detector 180, base code identification system 182, change aggregation system 184, change selector 186, change location identification system 188, recursive payload generator 190, and any of a wide variety of other system functionality 192. Recursive payload generator 190 can include needed item identification system 194, generated item identification system 196, recursive processor 198, and other items 200. Before describing the operation of computing system architecture 100 and build payload generation system 116 in more detail, a description of some of the items in build payload generation system 116, and their operation, will first be provided.

Build trigger detector 180 detects trigger criteria indicating that a build artifact 152 should be generated. Those trigger criteria may be time-based criteria, change-based criteria, or other criteria. Base code identification system 182 then identifies the base code for which a build artifact is to be generated. The base code may identify the code base 124 and the last time a build artifact was generated for that code base. Change aggregation system 184 then aggregates all of the changes or revisions that have been made to the code base 124 since the last time a build artifact was generated for the base code. Change selector 186 then selects a change from the aggregated changes, and change location identification system 188 identifies the location (and, in some examples, the content) of that change. The location of the change may identify a particular underlying binary or file where the change was made, for example. In one example, change location identification system 188 calls a data service 117 (such as through an exposed application programming interface (API) or in another way). The data service 117 may provide information about changes or files where changes were made, among other things. For instance, when a change is made based on a commit operation, information about that change can be collected by data service 117. The information can include information identifying the underlying file or binary that was changed, the time when the change was made, etc.

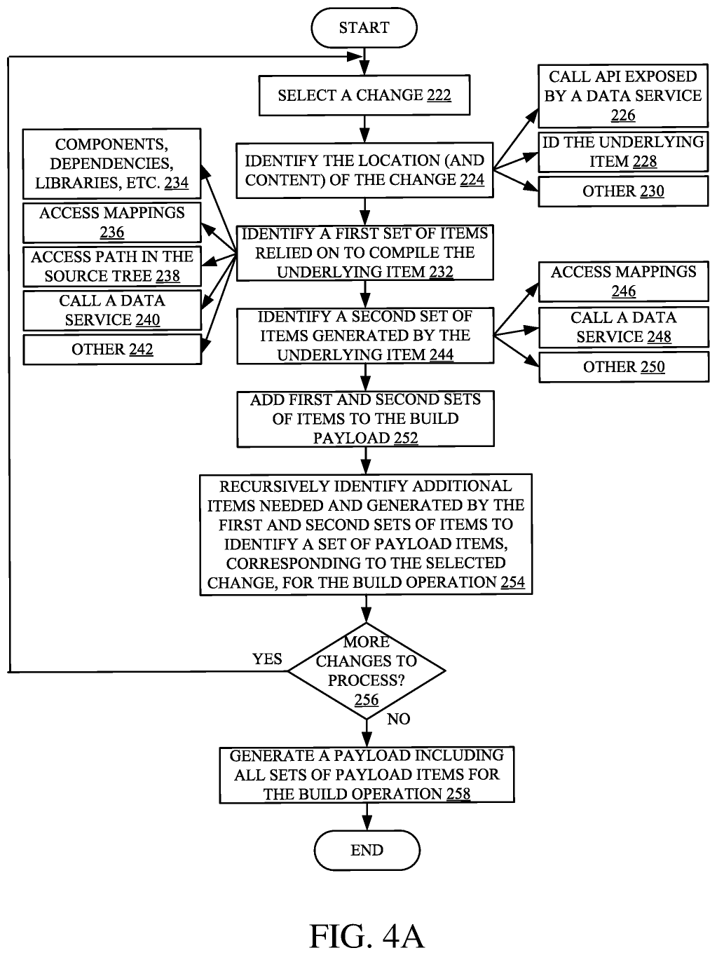

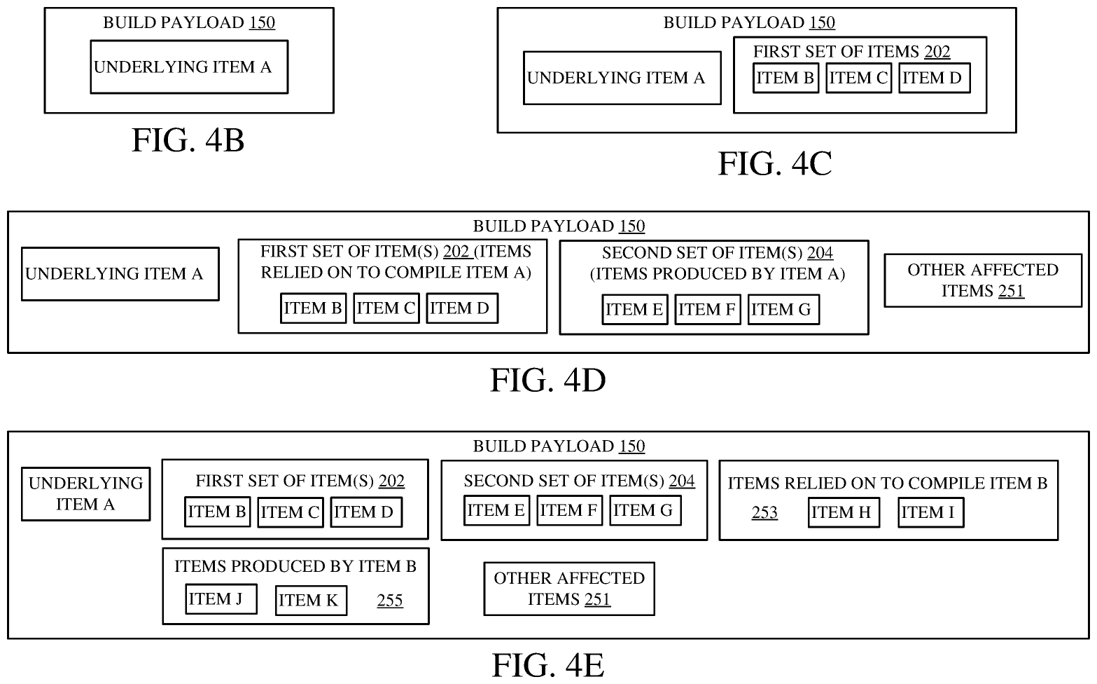

In one example, change selector 186 selects one of the changes for processing to determine what items need to be added to build payload 150 based upon the selected change. Change location identification system 188 identifies the underlying file or binary or other item where the change was made. That location (or underlying item) is then provided to recursive payload generator 190 which identifies other items affected by the change and adds those other items to build payload 150. Then, for each of the other items added to the build payload 150, recursive payload generator 190 processes the items that have been added to the build payload 150 to identify additional items that are affected by those other items. This process continues recursively to build up everything that is needed in the build payload 150 so that when a build artifact is generated based on the build payload 150, that build artifact represents all changes or revisions to the code base 124 since the last build artifact was generated. Generating build payload 150 is described in greater detail below with respect to FIGS. 4A-4E.

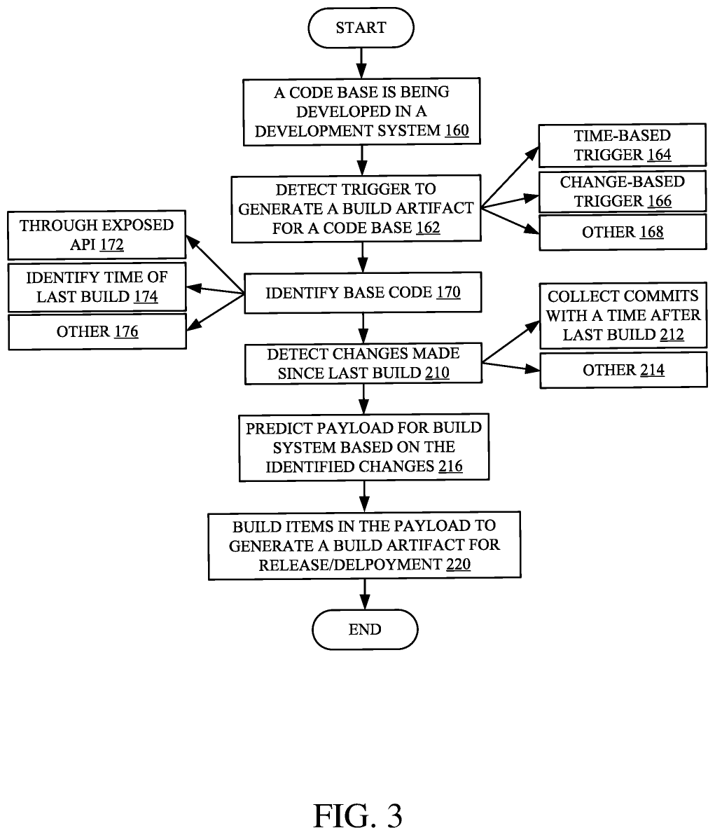

FIG. 3 is a flow diagram illustrating one example of the operation of computing system architecture 100 and build payload generation system 116, in more detail. It is assumed that a code base 124 in code repository 118 is being developed using a development system, such as continuous integration system 112. Build trigger detector 180 in build payload generation system 116 detects a trigger to generate a build artifact for the code base 124, to reflect any changes that have been made by developers 138 and 144 since the last build artifact was generated. Detecting a trigger is indicated by block 162. In one example, the trigger criteria are time-based trigger criteria 164 so that a new build artifact is generated periodically or otherwise intermittently based upon the passage of time. Alternatively or additionally, the trigger criteria are change-based trigger criteria 166, such that when a threshold number of commit operations have been performed or when changes have been made to certain computing system components, a build operation is triggered. These are only examples of the different types of change-based trigger criteria that can be used. In another example, the trigger may be detected based on other trigger criteria 168, in addition or alternatively to the time-based trigger criteria 164 and/or the change-based trigger criteria 166.

Base code identification system 182 in build payload generation system 116 then identifies the base code as indicated by block 170 in the flow diagram of FIG. 2. The base code represents the code base 124 in code repository 118 that existed when the last build artifact was generated for that code. The base code can be identified through an API exposed by code repository 118, as indicated by block 172, or in other ways. In one example, base code identification system 182 identifies the last time that a build artifact was generated for the base code, as indicated by block 174. The base code can be identified in other ways, and other information can alternatively or additionally be identified about the base code, as indicated by block 176.

Change aggregation system 184 in build payload generation system 116 then detects any changes made since the last build artifact was generated for this code base. Detecting the changes is indicated by block 210 in the flow diagram of FIG. 3. For instance, one or more of the data services 117 or other data sources 119 may provide a list of changes that were made in commit operations and the time those changes were made. In one example, data services 117 and/or other data sources 119 can be configured to track relationships among various items in code base 124. For instance, where one item calls another item in code base 124, this can be noted or otherwise recorded by data service 117 or other data sources 119. Where one item produces another item or relies on a separate item, these relationships can be noted or recorded as well. Also, for instance, where an item relies on an external dependency or another type of dependency, that relationship can also be identified. Therefore, those relationships can be used in order to identify items that are affected by changes made through a commit operation. The affected items can then be used to generate a build artifact, without needing to generate a build artifact for unaffected items.

The commits that were made at a time after the most recent previous build artifact was generated may be collected by change aggregation system 184, as indicated by block 212. The changes can alternatively or additionally be detected and collected in other ways, as indicated by block 214.

Build payload generation system 116 then predicts the build payload 150 that can be provided to build system 120 based upon the identified changes and/or commit operations, as indicated by block 216, and as described in greater detail below with respect to FIGS. 4A-4D.

Build system 120 builds (e.g., compiles) the items in build payload 150 to generate a build artifact 152 for release or deployment, as indicated by block 220 in the flow diagram of FIG. 3. The build artifact 152 includes all items needed to run the current version of code in code base 124.

FIG. 4A is a flow diagram illustrating one example of the operation of build payload generation system 116 in predicting the build pay load 150 in more detail. Once change aggregation system 184 aggregates the changes that have been made since the last build artifact was generated, then change selector 186 selects a change for processing, as indicated by block 222 in the flow diagram of FIG. 4A. Change location identification system 188 then identifies the location (and, in some examples, content) of the selected change, as indicated by block 224 in the flow diagram of FIG. 4A. For instance, change location identification system 188 can parse the commit operation to identify the location (e.g., the underlying file or binary or other item) where the selected change was made. In another example, this can be done by calling an API exposed by a data service 117 and/or by accessing another data source 119, as indicated by block 226, to identify a file or other item that was changed, as indicated by block 228. Identifying the location of the change can alternatively or additionally be done in other ways, as indicated by block 230.

It will be assumed for the sake of the present description that an underlying item A that was modified by the selected change is a file. FIG. 4B shows one example of build payload 150 after the underlying item A has been identified and added to build payload 150.

Needed item identification system 194 then identifies a first set of items 202 that are needed or relied on to compile the underlying item A, as indicated by block 232 in the flow diagram of FIG. 4A.

The needed item identification system 194 can identify various different types of needed items, such as computing system components, dependencies, files, libraries, etc., as indicated by block 234 in the flow diagram of FIG. 4A. The needed items can alternatively or additionally be obtained by accessing the mappings 128 that map different items to one another in code repository 118. Accessing the mappings is indicated by block 236 in the flow diagram of FIG. 4A. The needed items can alternatively or additionally be obtained by accessing a path 132 in the source tree, as indicated by block 238 in the flow diagram of FIG. 4A. The identity of the needed items can alternatively or additionally be obtained by calling a data service 117 that tracks the dependency among the different items in code base 124, as indicated by block 240. The needed items can alternatively or additionally be identified by accessing other data sources 119 or in a wide variety of other ways 242 as well.

In the example shown in FIG. 4C, build payload 150 now includes underlying item A as well as the first set of items 202 relied on to compile underlying item A. In the example shown in FIG. 4C, the first set of items 202 includes items B, C, and D.

Generated item identification system 196 also identifies the second set of items 204 representing the items that are generated by the underlying item A, as indicated by block 244 in the flow diagram of FIG. 4A. Again, generated item identification system 196 can access mappings 128, as indicated by block 246 in the flow diagram of FIG. 4A, and/or access the paths 132 in source tree 130, or call a data service 117, or another data source 119, as indicated by block 248, or identify the generated items in a wide variety of other ways 250.

FIG. 4D shows that the first and second sets of items 202, 204 have been added to the build payload 150, as indicated by block 252 in the flow diagram of FIG. 4A. Other items 251 (e.g., dependencies) that are affected by the selected change can also be added to build payload 150.

Then, for each of the items that have been added to the build payload 150, recursive processor 198 recursively selects each of those items and identifies the items that are needed by them and the items that are generated by them to identify additional items that are to be added to the build payload 150. Recursively identifying additional items to add to the build payload is indicated by block 254 in the flow diagram of FIG. 4A.

By way of example, recursive processor 198 may select item B and then use needed item identification system 194 to identify other items 253 that are relied on to compile item B. In the example shown in FIG. 4E, items 253 include items H and I. Recursive processer 198 may then use generated item identification system 196 to identify items 255 produced by item B. In the example shown in FIG. 4E, items 255 include items J and K. Recursive processor 198 then recursively selects item C, adds sets of items for item C, then selects item D and adds sets of items for item C, etc., recursively building up payload 150.

Once all of the items have been identified and added to the build payload 150, then change selector 186 determines whether there are additional changes to process (changes made since the last build), as indicated by block 256. If so, processing reverts to block 222 where the next change is selected, the underlying modified file (or underlying item where that change was made) is identified, items needed to compile that underlying item and generated by that underlying item are identified and added to the build payload, and additional items are recursively identified and added to the build payload for the newly selected change.

If, at block 256, change selector 186 determines that there are no more changes to process, then recursive payload generator 190 outputs the build payload 150 including all the sets of payload items, for the build operation to be executed by build system 120. Outputting the payload to build system 120 is indicated by block 258 in the flow diagram of FIG. 4A.

It can thus be seen that the present description describes a system that identifies changes that have been made to a code base since a prior build artifact was generated. Based on those changes, items in the code base that have been affected by the changes are identified prior to generating a subsequent build artifact. The affected items are used to generate the subsequent build artifact so that a build artifact does not need to be generated for unaffected items. This greatly enhances the speed and efficiency with which a build artifact, embodying changes made to the code base, can be generated and deployed. Thus, this reduces the computing system resources that are needed to deploy updates to the underlying code base.

It will be noted that the above discussion has described a variety of different systems, components, selectors, detectors, and/or logic. It will be appreciated that such systems, components, selectors, detectors, and/or logic can be comprised of hardware items (such as processors and associated memory, or other processing components, some of which are described below) that perform the functions associated with those systems, components, selectors, detectors, and/or logic. In addition, the systems, components, selectors, detectors, and/or logic can be comprised of software that is loaded into a memory and is subsequently executed by a processor or server, or other computing component, as described below. The systems, components, selectors, detectors, and/or logic can also be comprised of different combinations of hardware, software, firmware, etc., some examples of which are described below. These are only some examples of different structures that can be used to form the systems, components, selectors, detectors, and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The user actuatable input mechanisms can also be actuated in a wide variety of different ways. For instance, the user actuatable input mechanisms can be actuated using a point and click device (such as a track ball or mouse). The user actuatable input mechanisms can be actuated using hardware buttons, switches, a joystick or keyboard, thumb switches or thumb pads, etc. The user actuatable input mechanisms can also be actuated using a virtual keyboard or other virtual actuators. In addition, where the screen on which the user actuatable input mechanisms are displayed is a touch sensitive screen, the user actuatable input mechanisms can be actuated using touch gestures. Also, where the device that displays them has speech recognition components, the user actuatable input mechanisms can be actuated using speech commands.

A number of data stores have also been discussed. It will be noted that the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

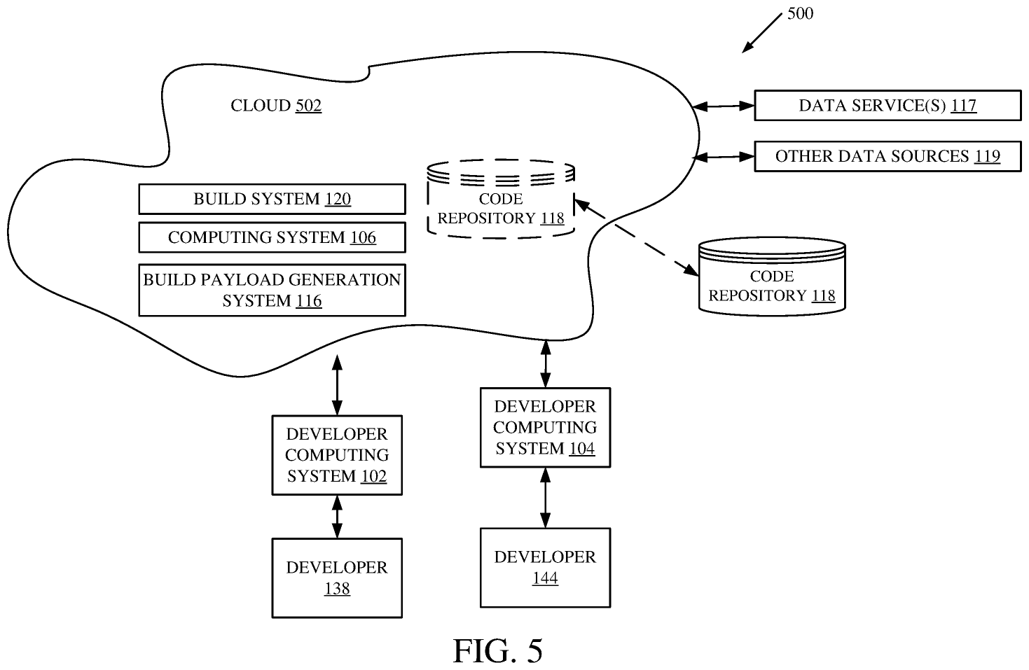

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, the components and functions can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that computing system 106, build system 120, build payload generation system 116, and/or code repository 118 can be located in cloud 502 (which can be public, private, or a combination where portions are public while others are private). Therefore, developers 138 and 144 use developer computing systems 102-104 to access those systems through cloud 502.

FIG. 5 also depicts another example of a cloud architecture. FIG. 5 shows that it is also contemplated that some elements of computing system 102 can be disposed in cloud 502 while others are not. By way of example, code repository 118, data services 117, and/or other data sources 119 can be disposed outside of cloud 502, and accessed through cloud 502. Regardless of where the items are located, the items can be accessed directly by device 504, through a network (either a wide area network or a local area network), they can be hosted at a remote site by a service, or can be provided as a service through a cloud or accessed by a connection service that resides in the cloud. All of these architectures are contemplated herein.

It will also be noted that architecture 100, or portions of architecture 100, can be disposed on a wide variety of different devices. Some of those devices include servers, desktop computers, laptop computers, tablet computers, or other mobile devices, such as palm top computers, cell phones, smart phones, multimedia players, personal digital assistants, etc.

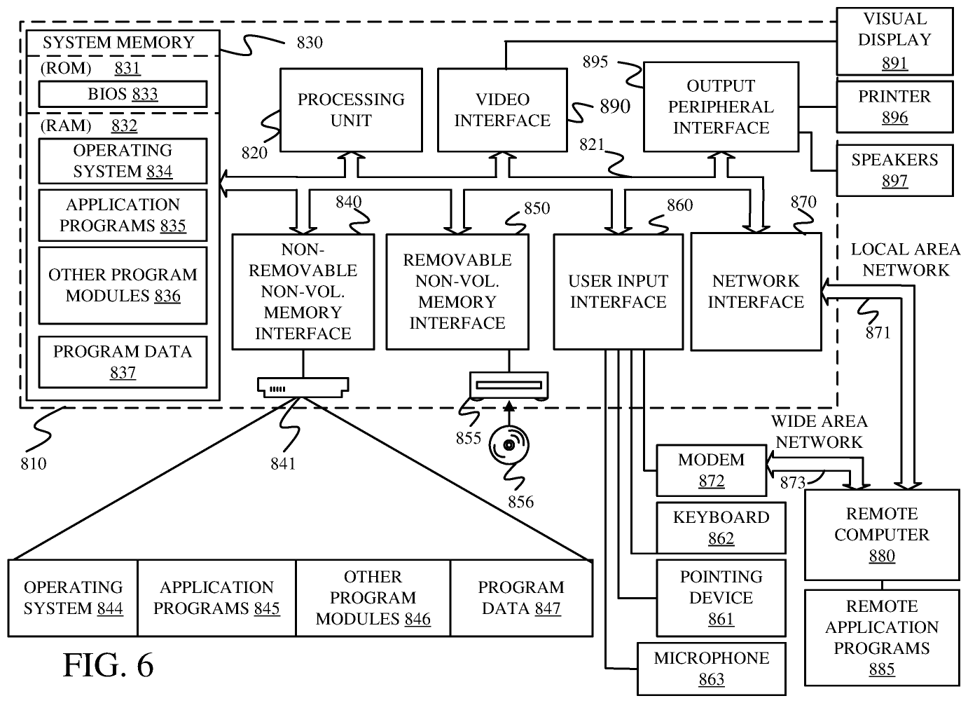

FIG. 6 is one example of a computing environment in which architecture 100, or parts of it, (for example) can be deployed. With reference to FIG. 6, an example system for implementing some embodiments includes a computing device in the form of a computer 810 programmed to operate as described above. Components of computer 810 may include, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 6.

Computer 810 typically includes a variety of computer readable media. Computer readable media can be any available media that can be accessed by computer 810 and includes both volatile and nonvolatile media, removable and non-removable media. By way of example, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, FIG. 6 illustrates operating system 834, application programs 835, other program modules 836, and program data 837.

The computer 810 may also include other removable/non-removable volatile/nonvolatile computer storage media. By way of example only, FIG. 6 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the example operating environment include magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 6, provide storage of computer readable instructions, data structures, program modules and other data for the computer 810. In FIG. 6, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 6 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 6 illustrates remote application programs 885 as residing on remote computer 880. It will be appreciated that the network connections shown are examples and other means of establishing a communications link between the computers may be used.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
identifying a change to code in a code base;
identifying an underlying item in the code base that is modified by the change;
accessing a data source to identify a related item in the code base that is likely to change based on the identified change to the underlying item;
generating a build payload that identifies, as payload items, the underlying item and the related item; and
generating a build artifact corresponding to the build payload.

2. The computer implemented method of claim 1 wherein accessing a data source comprises:
identifying items used to compile the payload items, wherein generating the build payload comprises identifying, as additional payload items, the items used to compile the payload items.

3. The computer implemented method of claim 2 wherein accessing a data source comprises:
identifying items generated by the payload items when the payload items are compiled, wherein generating the build payload comprises identifying, as additional payload items, the items generated by the payload items when the payload items are compiled.

4. The computer implemented method of claim 3 and further comprising:
recursively identifying, as recursively identified items, additional related items based on the payload items and the additional payload items, and wherein generating the build payload includes identifying as additional payload items, the recursively identified items.

5. The computer implemented method of claim 1 wherein accessing a data source to identify a related item comprises:
identifying a path in a source tree corresponding to the code base, the path including a representation of the underlying item.

6. The computer implemented method of claim 1 wherein accessing a data source to identify a related item comprises:
identifying dependent code used by the underlying item.

7. The computer implemented method of claim 1 wherein identifying a change to code in a code base comprises:
identifying a prior build time at which a prior build artifact was generated; and
identifying a set of changes made to the codebase since the prior build time.

8. The computer implemented method of claim 7 and further comprising:
repeating, for each change in the set of changes, steps of identifying an underlying item, accessing a data source, and generating the build payload.

9. The computer implemented method of claim 1 and further comprising:
detecting a build trigger to generate the build artifact, and wherein generating the build payload comprises generating the build payload based on the build trigger.

10. The computer implemented method of claim 9 wherein detecting a build trigger comprises:
detecting the build trigger based on time-based trigger criteria.

11. The computer implemented method of claim 9 wherein detecting a build trigger comprises:
detecting the build trigger based on change-based trigger criteria, the change-based trigger criteria being indicative of changes to the code base.

12. A computer system, comprising:
at least one processor; and
memory storing computer executable instructions which, when executed by the at least one processor, cause the at least one processor to perform steps, comprising:
detecting a change to code in a code base;
identifying an underlying item in the code base that is modified by the change;
accessing a data source to identify a related item in the code base that changes based on the identified change to the underlying item;
generating a build payload that identifies, as payload items, the underlying item and the related item; and
outputting the build payload to a build system for generation of a build artifact corresponding to the build payload.

13. The computer system of claim 12, the steps further comprising:
recursively identifying, as recursively identified items, additional related items based on the payload items, and wherein generating the build payload comprises generating the build payload identifying, as additional payload items, the recursively identified items.

14. The computer system of claim 13, the steps further comprising:
generating the build artifact based on the build payload.

15. The computer system of claim 12 wherein accessing a data source comprises:
identifying items used to compile the payload items, wherein generating a build payload comprises identifying, as additional payload items, the items used to compile the payload items.

16. The computer system of claim 12 wherein accessing a data source comprises:
identifying items generated by the payload items when the payload items are compiled, wherein generating the build payload comprises identifying, as additional payload items, the items generated by the payload items when the payload items are compiled.

17. The computer system of claim 12 wherein accessing a data source to identify a related item comprises:
identifying a path in a source tree corresponding to the code base, the path including a representation of the underlying item.

18. The computer system of claim 12 wherein accessing a data source to identify a related item comprises:
identifying dependent code used by the underlying item.

19. A computer system, comprising:
at least one processor;
a change aggregation system, implemented by the at least one processor, detecting a change to code in a code base;
a change location identification system identifying an underlying item in the code base that is modified by the change; and
a recursive payload generator accessing a data source to identify a related item in the code base that changes based on the identified change to the underlying item, generate a build payload that identifies, as payload items, the underlying item and the related item, and outputs the build payload to a build system for generation of a build artifact corresponding to the build payload.

20. The computer system of claim 19 wherein the recursive payload generator comprises:
a recursive processor configured to recursively identify, as recursively identified items, additional related items based on the payload items, and wherein the recursive payload generator is configured to generate the build payload identifying, as additional payload items, the recursively identified items.
